(19) United States
(12) Patent Application Publication
(10) Pub. No.: US 2006/0291539 A1
(43) Pub. Date: Dec. 28, 2006

(54) Transmit signal combining to allow passive recovery in a spread spectrum receiver

(76) Inventors: Ralph Eric Tischler, Richmond (CA); Sarkis Teghararian, Vancouver (CA)

Correspondence Address: PILLSBURY WINTHROP SHAW PITTMAN, LLP, P.O. BOX 10500, MCLEAN, VA, 22102, US

(21) Appl. No.: 11/451,345

(22) Filed: Jun. 13, 2006

Related U.S. Application Data
(60) Provisional application No. 60/689,556, filed on Jun. 13, 2005.

(51) Int. Cl. H04B 1/00

(52) U.S. Cl. 375/146

(57) ABSTRACT

A method for transmitting a spreading data signal and an intelligence signal to allow a passive recovery. Before transmission, the spreading data signal and the intelligence signal are filtered by a high-pass filter and a low-pass filter, respectively. The filtered spreading data signal and the intelligence signal are then summed to compose a composite intelligence/spreading signal (CISS). Due to the high-pass and low-pass filtering, the spreading data signal and the intelligence signal of the CISS are separated in the frequency domain. Next, the CISS is modulated by a RF modulator before transmitting to a remote receiver. As the spreading data signal and the intelligence signal of the CISS are separated in the frequency domain, the remote receiver can easily recover the intelligence signal from the received modulated CISS without complicated conversion devices.

This application claims the benefit of U.S. Provisional Application No. 60/689,556, filed Jun. 13, 2005, which is herein incorporated by reference in its entirety.

### BACKGROUND OF THE INVENTION

1. Field of the Invention

Embodiments of the present invention relate to digital spread spectrum communications. More particularly, embodiments of the present invention relate to systems and methods for combining intelligence and digital spreading signals for radio frequency transmission of a spread spectrum carrier.

2. Background Information

Current implementations of digital spread spectrum require complicated and expensive circuitry to recover or de-spread the transmitted spread spectrum signal at the receiver to extract the originating intelligence signal. These implementations typically employ a correlation mechanism in the spread spectrum receiver which matches a pseudo random digital spreading code to that which is used in the spreading of the transmitted signal.

In a typical implementation, the matched digital sequence is recombined with the received analog spread signal in a way that allows the digital spreading signal to be completely cancelled out or removed, leaving only the originating analog signal at the output (typically this analog signal is comprised of voice band speech).

Known implementations include U.S. Pat. Nos. 6,314,128, 5,673,323, 4,639,932, 4,351,064, 5,121,407, 6,256,337, 6,005,886, 4,351,064, 5,892,792, 6,128,510, 5,150,377, 5,511,090, and reissued RE35209. For example, U.S. Pat. No. 6,005,886 describes a basic technique of passive recovery (called synchronization free demodulation). This implementation employs amplitude modulation (AM) of the analog information signal with the digital spreading code. It then utilizes an AM envelope detector and filter to extract the original analog information signal.

There is also a previous product that has been produced by PANASONIC® that employs analog spread spectrum. Additional information can be found on the FCC website: https://gullfoss2.fcc.gov/prod/oet/cf/eas/reports/GenericSearch.cfm, by entering “ACJ” in the “Enter Grantee code:” filed and “96NKX-TG210A” in the “Enter Product Code:” field.

In view of the foregoing, it can be appreciated that a substantial need exists for systems and methods that can advantageously decrease the complexity and cost of circuitry to recover or de-spread the transmitted spread spectrum signal at the receiver to extract the originating intelligence signal.

### SUMMARY OF THE INVENTION

Embodiments of the present invention provide a method and system for combining intelligence and digital spreading signals for radio frequency transmission of a spread spectrum carrier and allowing extremely passive recovery of the intelligence signal in a radio receiver.

One embodiment of the invention provides a method for transmitting a spreading data signal and an intelligence signal to allow passive recovery. The method includes generating the spreading data signal using a spreading generator, high-pass filtering the spreading data signal to produce a high-pass filtered spreading data signal, low-pass filtering the intelligence signal to produce a low-pass filtered intelligence signal, summing the high-pass filtered spreading data signal and the low-pass filtered intelligence signal to produce a composite spreading data signal and intelligence signal, and modulating the composite spreading data signal and intelligence signal on an RF carrier.

Preferably, the spreading data signal and the intelligence signal of the composite spreading data signal and intelligence signal after the summing are separated in frequency domain before passing to the modulation step.

Embodiments of the present invention also provide a method for receiving an intelligence signal from a composite spreading data signal and intelligence signal modulated on an RF carrier using passive recovery. The method includes converting the RF carrier down to an intermediate frequency signal, demodulating the intermediate frequency signal to retrieve the composite spreading data signal and intelligence signal, and low-pass filtering the composite spreading data signal and intelligence signal to retrieve the intelligence signal.

In accordance with the invention, a transmitter for transmitting a spreading data signal and an intelligence signal to allow passive recovery includes a high-pass filer for filtering the spreading data signal, a low-pass filer for filtering the intelligence signal, a summing device for summing the spreading data signal and the intelligence signal after being filtered to form a composite spreading data signal and intelligence signal, and a modulator for modulating the composite spreading data signal and intelligence signal on a RF carrier. The transmitter further includes a local oscillator that determines a radio frequency that is utilized for transmission of the composite spreading data signal and intelligence signal to a remote receiver.

Embodiments of the invention further provide a receiver for receiving an intelligence signal from a composite spreading signal and intelligence signal modulated on an RF carrier. The receiver includes an oscillator and a mixer for converting the composite spreading signal and intelligence signal to intermediate frequency (IF) signal, a demodulator for demodulating the converted IF signal, and a low-pass filter for removing components of the spreading signal to obtain the intelligence signal. The receiver further includes an IF filter for filtering the IF signal before passing the IF signal to the demodulator.

Embodiments of the invention further provides a digital spread spectrum communications system. The system includes a transmitter and a receiver. The transmitter includes a high-pass filter for filtering a spreading signal, a low-pass filter for filtering an intelligence signal, a summing device for summing the spreading signal and the intelligence signal after being filtered to output a composite spreading signal and the intelligence signal, and a modulator for modulating the composite spreading signal and the intelligence signal on a RF carrier. The receiver includes a mixer and an oscillator for converting the composite spreading signal and intelligence signal to intermediate frequency (IF) signal, a demodulator for demodulating the converted IF signal, and a low-pass filter for removing components of the spreading signal to obtain the intelligence signal.

### BRIEF DESCRIPTION OF THE DRAWINGS

FIG. 1 is a schematic diagram showing a system for transmitting and receiving a spreading data signal and an intelligence signal, in accordance with an embodiment of the present invention.

FIG. 2 is an exemplary spreading data signal waveform, in accordance with an embodiment of the present invention.

FIG. 3 is an exemplary intelligence signal waveform, in accordance with an embodiment of the present invention.

FIG. 4 is an exemplary composite spreading data signal and intelligence signal waveform.

FIG. 5 is an exemplary plot of waveform amplitude and frequency showing an intelligence signal frequency occupation as a result of low-pass filtering, in accordance with an embodiment of the present invention.

FIG. 6 is an exemplary plot of waveform amplitude and frequency showing a spreading data signal frequency occupation as a result of high-pass filtering, in accordance with an embodiment of the present invention.

FIG. 7 is an exemplary plot of waveform amplitude and frequency showing a composite spreading data signal and intelligence signal frequency occupation as a result of low-pass filtering and high-pass filtering, in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

One embodiment of the present invention is a method for combining intelligence and digital spreading signals for radio frequency transmission of a spread spectrum carrier. This embodiment allows for extremely simple and cost effective recovery of the intelligence signal in the radio receiver. The goal of this embodiment is to develop a simple and cost effective method to achieve the intelligence signal recovery and still benefit from the enhanced security provided by digital spreading.

This embodiment employs no method for correlation to the originating digital spreading signal, nor does it employ a method for matching and subsequent cancellation of the digital spreading signal as a means to recover the originating analog signal. This embodiment uses a “passive” high-pass filtering scheme to suppress the digital spreading signal from overlapping the baseband spectrum of the desired analog signal to be transmitted. At the receiver, the recovery of the analog signal is accomplished by simply demodulating the spread signal and low-pass filtering to remove any components of the digital spreading signal, which may be falling into the desired intelligence frequency band.

This embodiment employs frequency separation and summing of the analog signal and digital spreading code and then utilizes frequency modulation (FM) and subsequent FM demodulation of the combined signal.

Another embodiment of the present invention is intended to enhance the capability of an existing analog cordless phone to incorporate spread spectrum technology to enhance the security of the analog phone and to be able to qualify under the Federal Communications Commission (FCC) part 15 rules under the category of digital modulation. Enhancement of the security of the analog phone is accomplished by the addition of the digital spreading to the analog modulated signal, making it more difficult for a conventional scanner or other cordless telephone to listen in to a conversation. Qualification under the FCC part 15 rules under the category of digital modulation allows transmission at higher output power and extended range.

Another embodiment of the present invention involves separating a spreading data signal and analog audio or an intelligence in the frequency domain before sending out to a remote receiver. As the spreading data signal and the intelligence data are separated in the frequency domain, the intelligence domain can be easily recovered (i.e., passive recovery) from a combined spreading signal and intelligence data.

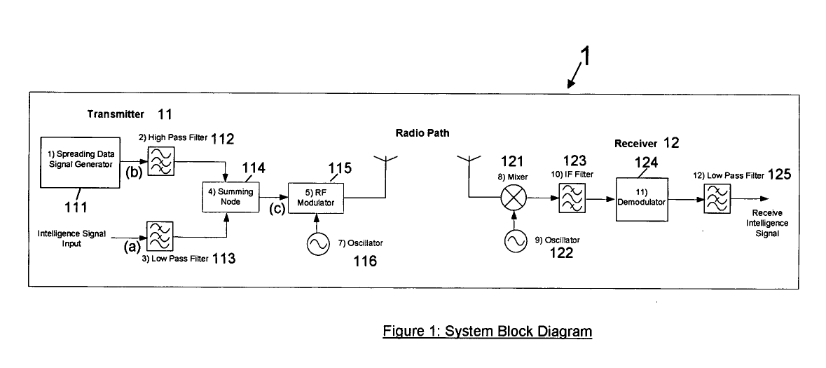

FIG. 1 illustrates an exemplary system 1 for digital spread spectrum communications in accordance with the present invention. As illustrated, system 1 includes a transmitter side 11 and a receiver side 12. At the transmitter side, a digital spreading signal (b) generated by a spreading data signal generator 111 and an intelligence signal (a) are input to a high-pass filer 112 and a low-pass filter 113, respectively. The digital spreading signal may be a repetitive or pseudo-random sequence in nature. The characteristics of the spreading signal sequence are designed to reduce the lower frequency content that overlaps with an intelligence frequency band. As the spreading signal is assumed to be much higher in frequency than the intelligence signal, the digital spreading signal is applied to high-pass filter 112. The analog audio or intelligence signal is applied to the input of low-pass filter 113.

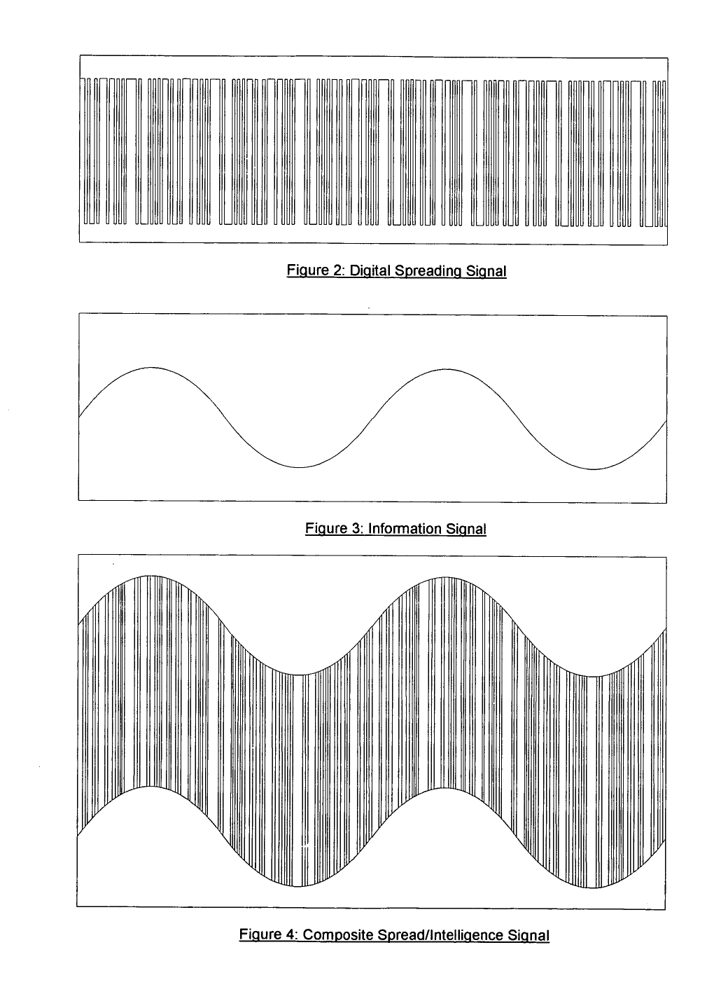

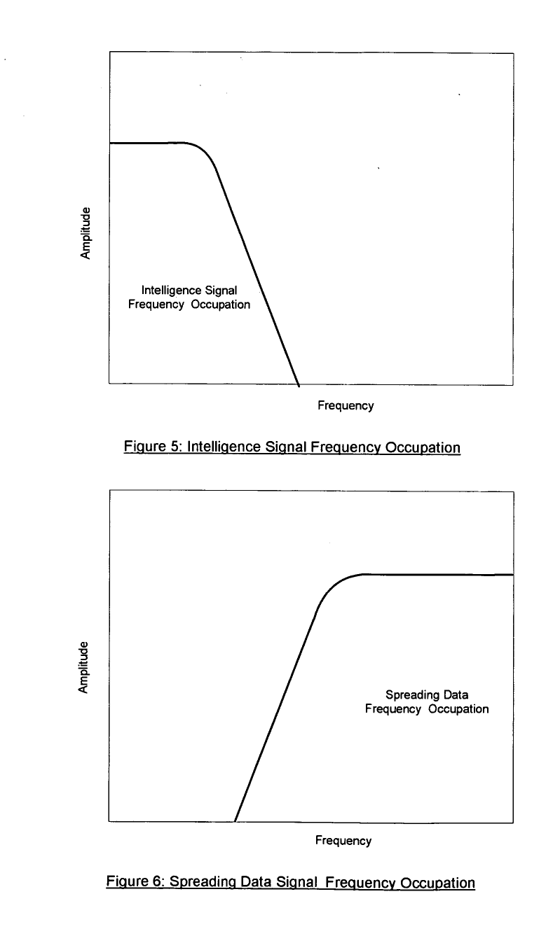

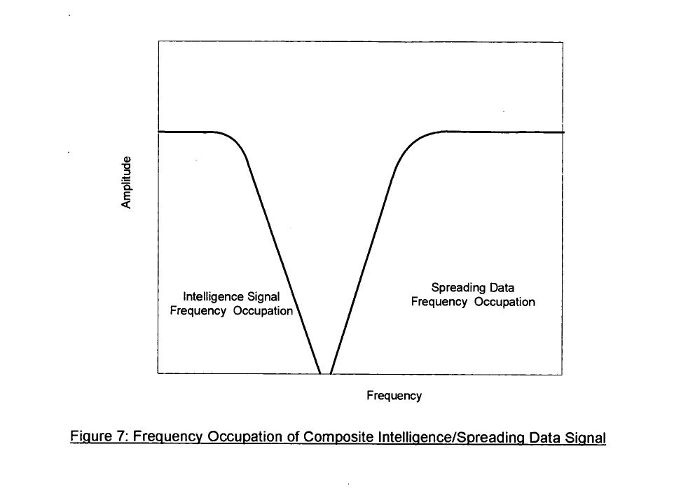

FIGS. 2 and 3 illustrate exemplary waveforms of a digital spreading signal and a typical example of an analog audio signal at the intelligence signal input, respectively. A composite waveform of the spread/intelligence signal will be illustrated in FIG. 4. In FIG. 1, the purpose of the high-pass and low-pass filters 112 and 113 is to process the intelligence and spreading signals so that at the output of the filters the intelligence signal will not contain any signal frequency content spilling over into the spreading frequency band, nor, more importantly, will the spreading signal output provide any signal spilling over into the intelligence frequency band. After the filtering, FIG. 5 shows the intelligence signal frequency occupation as a result of low-pass filtering (shown at output of low-pass filter 113). FIG. 6 shows the spreading data signal frequency occupation as a resultant of both the data frequency and pattern as well as the subsequent high-pass filtering (shown at output of high-pass filter 112).

System 1 of FIG. 1 further includes a summing device 114, a radio frequency (RF) modulator 115 and a local oscillator 116. Summing device 114 is coupled to the outputs of high-pass filter 112 and low-pass filter 113 for summing the spreading data and the intelligence signals. Summing device 114 is a passive summing node that accomplishes the function of combining the intelligence signal (a) with the spreading signal (b), to form the composite intelligence/spreading signal (c).

FIG. 7 illustrates the output of summing device 114 where the composite intelligence/spreading data signal is observed. As shown, these signals are separated in the frequency domain before they are passed into RF modulator 5.

RF Modulator 115 is coupled to the output of summing device 114 for modulating the composite intelligence/spreading signal (CISS) onto an RF carrier for the purpose of RF transmission of the intelligence information. RF modulator 115 can employ any form of linear modulation such as frequency or amplitude modulation. Local oscillator 116 determines the radio frequency that will be utilized for transmission of the CISS to a remote receiver.

Receiver side 12 of system 1 includes an oscillator 122, mixer 121, and an IF filter 123 that are utilized to convert the CISS modulated RF signal received from transmitter side 11 down to an intermediate frequency (IF) which can then be passed to a demodulator 124. Preferably, the bandwidth of IF filter 123 is large enough to pass the entire modulation envelope of the CISS modulated RF carrier. The IF signal is then demodulated by demodulator 124. According to the invention, the output of demodulator 11 is the original CISS waveform.

Next, receiver side 12 recovers an intelligence signal from the demodulated CISS waveform. The recovery of the intelligence signal is now possible due to the fundamental frequency separation of the intelligence and spreading data signals at the transmitter that is shown in FIG. 7. As shown, a low-pass filter 125 is coupled to the output of demodulator 124 so that the CISS is passed through low-pass filter 115 to remove any components of the spreading data signal. The resultant is the fully restored intelligence signal.

Systems and methods in accordance with an embodiment of the present invention disclosed herein can advantageously allow for extremely simple and cost effective recovery of the intelligence signal in the radio receiver. The selection of the spreading data frequency, psuedo-random pattern, and scrambling techniques is used to shift the frequency spectrum of the spreading data signal out of the frequency band occupied by the intelligence signal. Further, high-pass filtering of the spreading data signal is employed to eliminate any residual frequency components that may fall into the intelligence frequency band. Finally, the intelligence and spreading data signals are combined into a composite intelligence/spreading data signal within which there is complete separation of the frequency occupation of the two signals. It is this mechanism that allows the composite signal to be RF modulated, received, and demodulated by conventional methods and the desired intelligence signal to be extracted from the composite waveform by simply applying low-pass filtering.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM (“CD-ROM”)) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

In the foregoing detailed description, systems and methods in accordance with embodiments of the present invention have been described with reference to specific exemplary embodiments. Accordingly, the present specification and figures are to be regarded as illustrative rather than restrictive. The scope of the invention is to be further understood by the numbered examples appended hereto, and by their equivalents.

What is claimed is:

1. A method for transmitting a spreading data signal and an intelligence signal to allow passive recovery, comprising:
generating the spreading data signal using a spreading generator;
high-pass filtering the spreading data signal to produce a high-pass filtered spreading data signal;
low-pass filtering the intelligence signal to produce a low-pass filtered intelligence signal;
summing the high-pass filtered spreading data signal and the low-pass filtered intelligence signal to produce a composite spreading data signal and intelligence signal; and
modulating the composite spreading data signal and intelligence signal on an RF carrier.

2. The method of claim 1, further comprising determining a radio frequency used for transmission of the composite spreading data signal and intelligence signal to a remote receiver.

3. The method of claim 1, wherein the composite spreading data signal and intelligence signal is modulated by a frequency modulation.

4. The method of claim 1, wherein the composite spreading data signal and intelligence signal is modulated by an amplitude modulation.

5. The method of claim 1, wherein the spreading data signal and the intelligence signal of the composite spreading data signal and intelligence signal are separated in frequency domain.

6. A method for receiving an intelligence signal from a composite spreading data signal and intelligence signal modulated on an RF carrier using passive recovery, comprising:
converting the RF carrier down to an intermediate frequency signal;
demodulating the intermediate frequency signal to retrieve the composite spreading data signal and intelligence signal; and
low-pass filtering the composite spreading data signal and intelligence signal to retrieve the intelligence signal.

7. The method of claim 6, wherein the conversion of the RF carrier to the intermediate frequency signal is performed by an oscillator and a mixer.

8. The method of claim 6, further comprising intermediate-frequency (IF) filtering the intermediate frequency signal before demodulation.

9. A transmitter for transmitting a spreading data signal and an intelligence signal to allow passive recovery, comprising:
a high-pass filer for filtering the spreading data signal;
a low-pass filer for filtering the intelligence signal;
a summing device for summing the spreading data signal and the intelligence signal after being filtered to form a composite spreading data signal and intelligence signal; and
a modulator for modulating the composite spreading data signal and intelligence signal on a RF carrier.

10. The transmitter of claim 9, further comprising an oscillator coupled to the modulator to determine a radio frequency used for transmitting the composite spreading data signal and intelligence signal to a remote receiver.

11. The transmitter of claim 9, wherein the modulator is a RF modulator.

12. The transmitter of claim 11, wherein the modulator employs a form of linear modulation that includes frequency and amplitude modulation.

13. The method of claim 9, further comprising a spreading data signal generator for generating the spreading signal.

14. A receiver for receiving an intelligence signal from a composite spreading signal and intelligence signal modulated on an RF carrier, comprising:
an oscillator and a mixer for converting the composite spreading signal and intelligence signal to intermediate frequency (IF) signal;
a demodulator for demodulating the converted IF signal; and
a low-pass filter for removing components of the spreading signal to obtain the intelligence signal.

15. The receiver of claim 14, further comprising an IF filter for filtering the IF signal before passing the IF signal to the demodulator.

16. The receiver of claim 15, wherein a bandwidth of the IF filter is large enough to pass an entire modulation envelop of the received composite spreading signal and intelligence signal modulated RF carrier.

17. A digital spread spectrum communications system, comprising:
a transmitter, comprising:
a high-pass filter for filtering a spreading signal;
a low-pass filter for filtering an intelligence signal;
a summing device for summing the spreading signal and the intelligence signal after being filtered to output a composite spreading signal and the intelligence signal; and
a modulator for modulating the composite spreading signal and the intelligence signal on a RF carrier; and
a receiver, comprising:
a mixer and an oscillator for converting the composite spreading signal and intelligence signal to intermediate frequency (IF) signal;
a demodulator for demodulating the converted IF signal; and
a low-pass filter for removing components of the spreading signal to obtain the intelligence signal.

18. The system of claim 17, wherein the receiver further comprises a IF filter for filtering the IF signal before passing the IF signal to the demodulator, wherein a bandwidth of the IF filter is large enough f to pass an entire modulation envelop of the composite spreading signal and intelligence signal modulated RF carrier.

19. The system of claim 17, wherein the output of the demodulator is the original composite spreading signal and intelligence signal waveform output from the summing device of the transmitter.

20. The system of claim 17, wherein the transmitter further comprises an oscillator coupled with the modulator for determining a radio frequency used for transmitting the modulated composite spreading signal and intelligence signal to the receiver.
